(19) United States
(12) Patent Application Publication
(10) Pub. No.: US 2014/0170871 A1
(43) Pub. Date: Jun. 19, 2014

(54) ELECTRONIC DEVICE WITH ROTABLE CONNECTOR

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: JIAN-GUO WU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/789,680

(22) Filed: Mar. 8, 2013

(30) Foreign Application Priority Data
Dec. 19, 2012 (CN) 201210553957.X

(51) Int. Cl. H01R 13/44

(52) U.S. Cl. CPC H01R 13/44
USPC 439/131

(57) ABSTRACT

An electronic device includes a housing, a circuit board, and a connecting member. The housing defines a receiving space and a opening communicating with the receiving space. The circuit board is accommodated in the receiving space. The connecting member includes a connector defining a socket and a cable electrically connecting the connector to the circuit board. The connecting member is rotatably received in the opening of the housing. The torsion spring is configured to rotate the connecting member out of the opening. The latching member is movably received in the housing. The latching member is slidable between a first position where an end of the latching member is latchingly received in the socket of the connector, thereby preventing the connecting member from extending out of the opening of the housing, and a second position where the latching member disengages from the socket.

### BACKGROUND

1. Technical Field

The present disclosure relates to an electronic device having a rotatable connector.

2. Description of Related Art

Generally, electronic devices, e.g. mobile phones, include a housing and an electrical receptacle in the housing. A corresponding data line with two plugs at opposite ends is often needed for connecting the electronic devices to an external device, such as a computer. Sometimes, when the data line is not handy, the electronic device cannot be connected to an external device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an electronic device with rotatable connector according to an exemplary embodiment.

FIG. 2 is a partial, exploded view of the electronic device of FIG. 1.

FIG. 3 is similar to FIG. 2, but viewed from a reverse direction.

FIG. 4 is a cross-sectional view of the electronic device, taken along line IV-IV of FIG. 1.

FIG. 5 is a cross-sectional view of the electronic device, showing the connector rotated out of the housing.

### DETAILED DESCRIPTION

Embodiments of the present disclosure are now described in detail, with reference to the accompanying drawings.

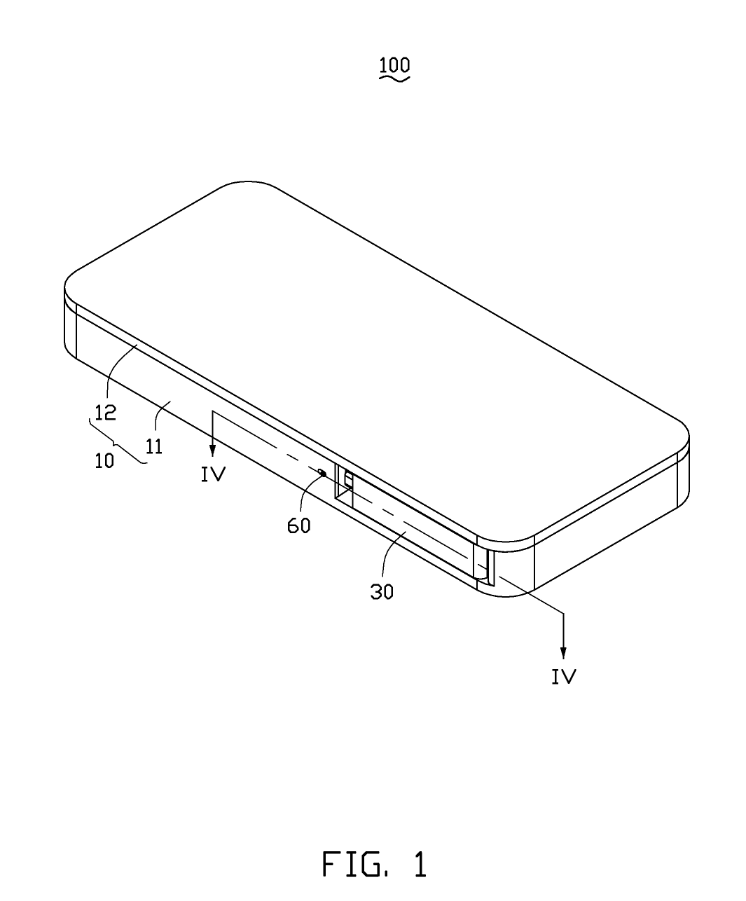

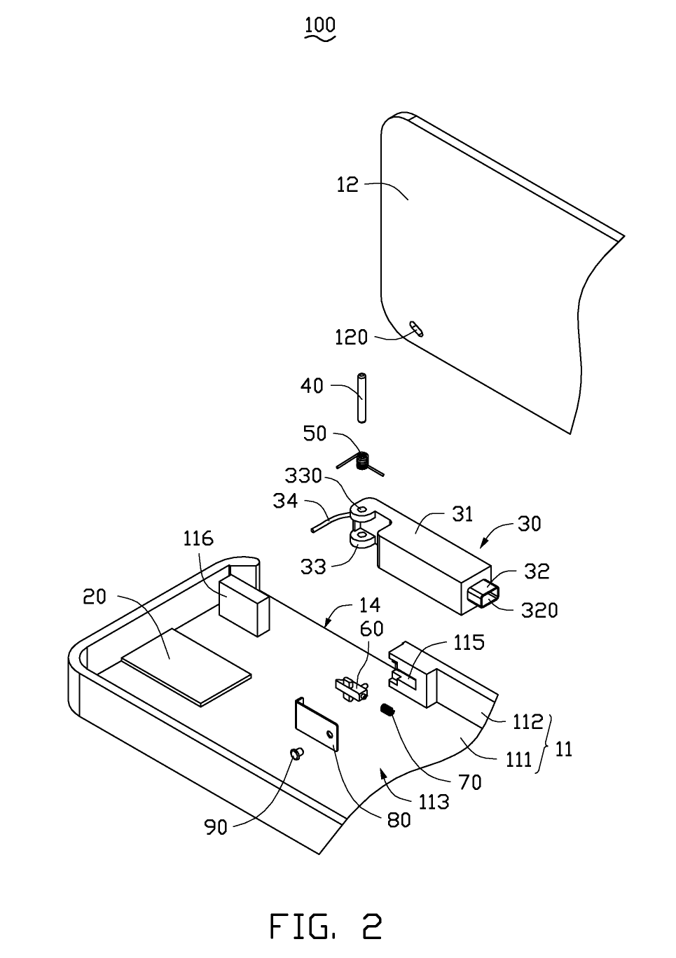

Referring to FIGS. 1-2, an electronic device 100 according to an exemplary embodiment is illustrated. The electronic device 100 includes a housing 10, a circuit board 20 located in the housing 10, a connecting member 30, a shaft 40, a torsion spring 50, a latching member 60, a resilient member 70, a covering plate 80, and a fastener 90.

The housing 10 includes a lower housing 11 and an upper housing 12 coupled to each other. The lower housing 11 includes a bottom plate 111 and a sidewall 112 protruding from the bottom plate 111, which cooperatively define a receiving space 113 therebetween. The circuit board 20 is accommodated in the receiving space 113, and located on the bottom plate 111. The sidewall 112 defines a opening 114 communicating with the receiving space 113, a T-shaped sliding groove 115 in an inner side, and a through orifice 118 communicating with the sliding groove 115. The lower housing 11 further includes a stopper block 116 protruding from the bottom plate 111 and adjacent to the opening 114.

The connecting member 30 includes an elongated arm portion 31, a connector 32 located at one end of the arm portion 31, and two spaced positioning tabs 33 located at another end of the arm portion 31. The connector 32 defines a socket 320. The positioning tabs 33 each define a positioning hole 330 aligned with one another. The connecting member 30 further includes a cable 34 electrically connecting the connector 32 to the circuit board 20.

The bottom plate 111 defines a first pivot hole 117, and the upper housing 12 defines a second pivot hole 120 aligned with the first pivot hole 117. The shaft 40 extends through the positioning holes 330 of the positioning tabs 33 with opposite ends respectively retained within the first pivot hole 117 and the second pivot hole 120. Thus, the connecting member 30 is rotatably received in the opening 114 of the lower housing 11.

The torsion spring 50 is coiled around the shaft 40 with opposite ends respectively abutting against the stopper block 116 and the connecting member 30. The torsion spring 50 applies a torsional force to the connecting member 30 for rotating the connecting member 30 out of the opening 114.

The latching member 60 is movably retained in the sliding groove 115 of the lower housing 11. The latching member 60 includes a rectangular main body 61, a positioning rod 62 protruding from one end, two positioning blocks 63 protruding from the top and the bottom of the main body 61, and a pushing rod 64 protruding from one side of the main body 61 and extending through the through orifice 118 of the lower housing 11. The main body 61 includes a side surface 611 in parallel to a sliding direction of the latching member 60 and an end surface 612 inclined to the sliding direction of the latching member 60. The end surface 612 is opposite to the positioning rod 62. The resilient member 70 is compressed between the lower housing 11 and the latching member 60. The resilient member 70 applies a pushing force to the latching member 60, which can push the latching member 60 out of sliding groove 115. In the embodiment, the resilient member 70 is a spring coil sleeved around the positioning rod 62.

The covering plate 80 defines a fastening hole 81 and includes two tabs 82 protruding from one end. The covering plate 80 is fixed to the sidewall 112 using the fastener 90 and covers the sliding groove 115, and the tabs 82 prevent the latching member 60 from disengaging from the sliding groove 115.

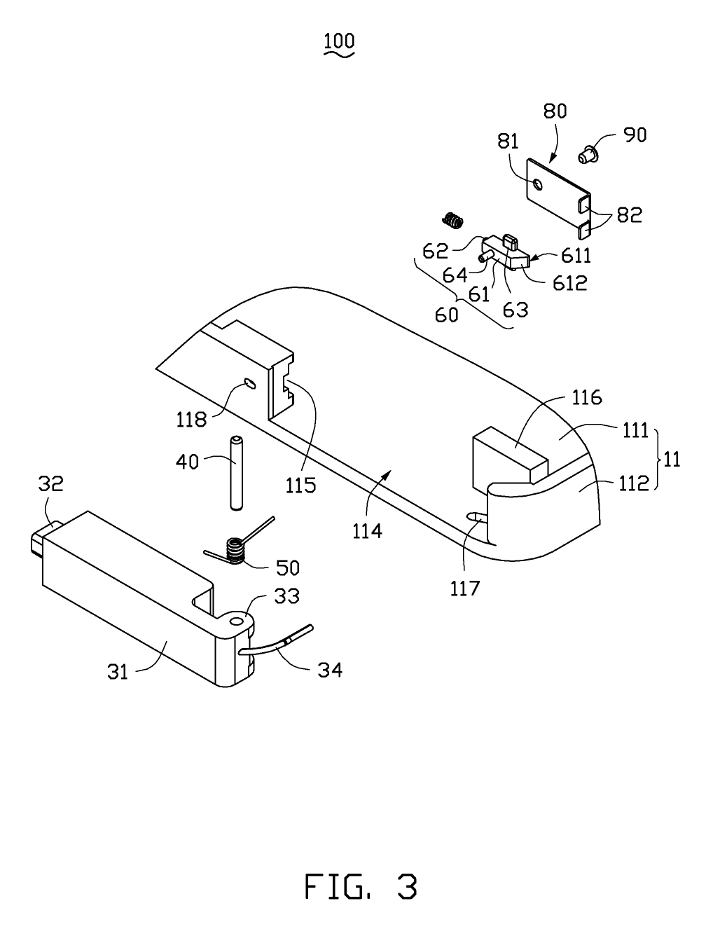

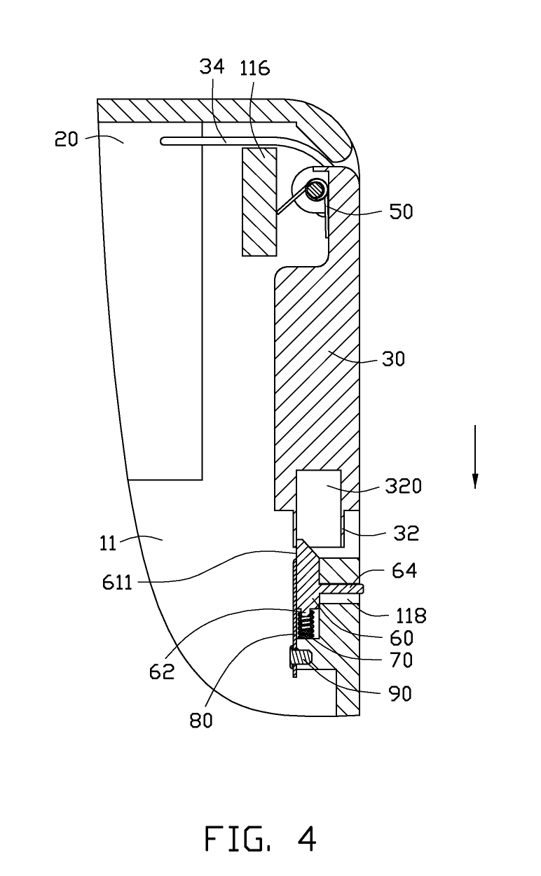

Referring to FIGS. 3 and 4, when the connector 32 is unoccupied, the connecting member 30 can be rotated into the opening 114. The connector 32 contacts the end surface 612 of the latching member 60 and drives the latching member 60 to move inward to the sliding groove 115. The latching member 60 is pushed by the resilient member 70 and the end of the latching member 60 is received in the socket 320 of the connector 32. The side surface 611 contacts a side surface of the socket 320, thereby preventing the connecting member 60 from rotating out of the opening 114.

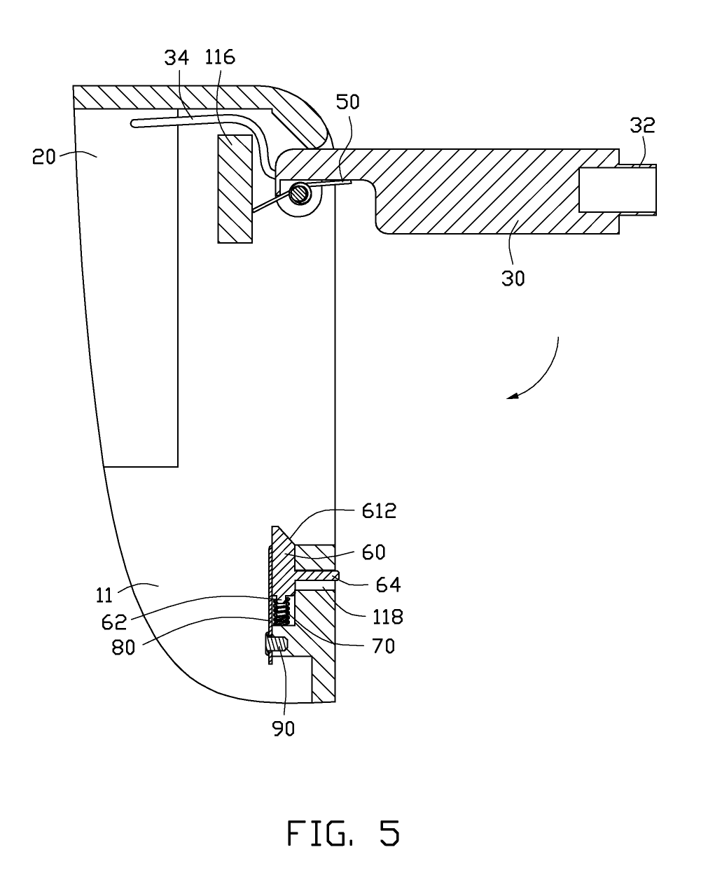

Referring to FIG. 5, when the pushing rod 64 is pushed to a position where the side surface 611 disengages from the side surface of the socket 320, the connecting member 30 is driven by the torsion spring 50 to rotate out of the opening 114. Thus, the connector 32 can be connected to another connector.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electronic device comprising:
a housing defining an inner receiving space and an opening communicating with the receiving space;
a circuit board accommodated in the receiving space;
a connecting member comprising a connector and a cable electrically connecting the connector to the circuit board, the connecting member being rotatably received in the opening of the housing, and the connector defining a socket;
a torsion spring configured to apply a torsional force to the connecting member for rotating the connecting member out of the opening; and
a latching member movably received in the housing, the latching member being slidable between a first position where an end of the latching member is latchingly received in the socket of the connector, thereby preventing the connecting member from rotating out of the opening of the housing, and a second position where the latching member disengages from the socket for releasing the connecting member.

2. The electronic device as described in claim 1, wherein the housing comprises a lower housing and an upper housing coupled to the lower housing, the lower housing comprises a bottom plate and a sidewall protruding from the bottom plate, which cooperatively define the receiving space therebetween, and the sidewall defines the opening.

3. The electronic device as described in claim 2, further comprising a shaft extending through the connecting member, wherein the bottom plate defines a first pivot hole, the upper housing defines a second pivot hole aligned with the first pivot hole, and the shaft comprises opposite ends retained within the first pivot hole and the second pivot hole, thereby rotatably connecting the connecting member to the housing.

4. The electronic device as described in claim 4, wherein the lower housing comprises a stopper block protruding from the bottom plate and adjacent to the opening, and the torsion spring is coiled around the shaft with opposite ends respectively abutting against the stopper block and the connecting member.

5. The electronic device as described in claim 2, wherein the side plate defines a T-shaped sliding groove, and the latching member is movably received in the sliding groove.

6. The electronic device as described in claim 5, further comprising a resilient member compressed between the lower housing and the latching member.

7. The electronic device as described in claim 6, wherein the latching member comprises a positioning rod, and the resilient member is a spring coil sleeved around the positioning rod.

8. The electronic device as described in claim 5, wherein the latching member comprises an end surface inclined to the sliding direction of the latching member.

9. The electronic device as described in claim 8, wherein the sidewall further defines a through slot communicating with the sliding groove, and the latching member further comprises a pushing rod connected to the main body and extending through the slot.

10. The electronic device as described in claim 5, further comprising a covering plate covering the sliding groove and a fastener fixing the covering plate to the lower housing.
